(19) United States
(12) Patent Application Publication
(10) Pub. No.: US 2023/0418538 A1
(43) Pub. Date: Dec. 28, 2023

(54) INFORMATION PROCESSING DEVICE, CONTENT DISPLAY SYSTEM, AND CONTENT DISPLAY METHOD

(71) Applicant: Sharp NEC Display Solutions, Ltd., Tokyo (JP)

(72) Inventor: Ryoichi ARAKI, Tokyo (JP)

(21) Appl. No.: 18/242,159

(22) Filed: Sep. 5, 2023

Related U.S. Application Data
(63) Continuation of application No. PCT/JP2021/012017, filed on Mar. 23, 2021.

(51) Int. Cl. G06F 3/14; G06Q 30/0251

(52) U.S. Cl. CPC G06F 3/1423; G06Q 30/0261; G06V 40/161

(57) ABSTRACT

An information processing device includes: a reception unit configured to receive an image capturing a first shooting range and a second shooting range different from the first shooting range, the first shooting range and the second shooting range being included in a region in which a first display region and a second display region different from the first display region are visible; and a processing unit configured to, when a plurality of persons are detected from the first shooting range and no person is detected from the second shooting range, assign to the first display region, a content corresponding to a first person detected from the first shooting range, and assign to the second display region, a content corresponding to a second person detected from the first shooting range.

### TECHNICAL FIELD

The present disclosure relates to an information processing device, a content display system, and a content display method.

This application is a Continuation Application of International Application No. PCT/JP2021/012017, filed on Mar. 23, 2021, the contents of which are incorporated herein by reference.

### BACKGROUND ART

In a targeted advertising system, when a plurality of viewers are recognized from a captured image, one viewer is detected based on a specific condition (for example, a size of a captured face). The targeted advertisement system selects a targeted advertisement corresponding to the detected viewer as a content to be played and displays the selected content on a display device.

In the case of this method, it is unlikely to expect the effect of the targeted advertising on viewers other than the viewer detected under the specific condition.

Further, there is a method in which even in a scene where a content is displayed using a plurality of video display devices, if a plurality of viewers are recognized from a captured image, a default advertisement is played without performing a process of selecting a targeted advertisement corresponding to the plurality of viewers (Patent Document 1).

### CITATION LIST

### Patent Document

[Patent Document 1] Japanese Patent Application Publication No. 2016-173528

### SUMMARY

### Technical Problems

The targeted content system is a method of playing a content targeted at only one viewer. For this reason, when a plurality of viewers are present, there is a problem that the viewers who are not selected as the targets will lose the chance to see the targeted content that could have been seen if only one viewer were present.

The present disclosure provides an information processing device, a content display system, and a content display method, which can increase the chances of viewing a targeted content even when a plurality of viewers are present.

### Solution to the Problems

An information processing device according to an aspect of the present disclosure includes: a reception unit configured to receive an image capturing a first shooting range and a second shooting range different from the first shooting range, the first shooting range and the second shooting range being included in a region in which a first display region and a second display region different from the first display region are visible; and a processing unit configured to, when a person is detected from a respective one of the first shooting range and the second shooting range based on the image, assign to the first display region, a content corresponding to the person detected from the first shooting range, and assign to the second display region, a content corresponding to the person detected from the second shooting range, and when a plurality of persons are detected from the first shooting range and no person is detected from the second shooting range, assign to the first display region, a content corresponding to a first person detected from the first shooting range, and assign to the second display region, a content corresponding to a second person detected from the first shooting range.

Further, a content display system according to an aspect of the present disclosure includes: a first display device having a first display region; and a second display device having a second display region, wherein when a person is present in a respective one of a first region and a second region different from the first region, the first region and the second region being included in a region in which the first display region and the second display region are visible, the first display device is configured to display a content corresponding to the person present in the first region, and the second display device is configured to display a content corresponding to the person present in the second region, and when a plurality of persons are detected from the first region and no person is detected from the second region, the first display device is configured to display a content corresponding to a first person detected from the first region, and the second display device is configured to display a content corresponding to a second person detected from the first region.

Further, a content display method according to an aspect of the present disclosure includes: receiving an image capturing a first shooting range and a second shooting range different from the first shooting range, the first shooting range and the second shooting range being included in a region in which a first display region and a second display region different from the first display region are visible; when a person is detected from a respective one of the first shooting range and the second shooting range based on the image, assigning to the first display region, a content corresponding to the person detected from the first shooting range, and assigning to the second display region, a content corresponding to the person detected from the second shooting range; and when a plurality of persons are detected from the first shooting range and no person is detected from the second shooting range, assigning to the first display region, a content corresponding to a first person detected from the first shooting range, and assigning to the second display region, a content corresponding to a second person detected from the first shooting range.

Further, a content display method according to an aspect of the present disclosure uses a first display device having a first display region and a second display device having a second display region, and the content display method includes: when a person is present in a respective one of a first region and a second region different from the first region, the first region and the second region being included in a region in which the first display region and the second display region are visible, displaying on the first display device, a content corresponding to the person present in the first region, and displaying on the second display device, a content corresponding to the person present in the second region; and when a plurality of persons are detected from the first region and no person is detected from the second region, displaying on the first display device, a content corresponding to a first person detected from the first region, and displaying on the second display device, a content corresponding to a second person detected from the first region.

### Advantageous Effects

According to the present disclosure, even when a plurality of viewers are present, it is possible to increase the chances of viewing a targeted content.

### BRIEF DESCRIPTION OF THE DRAWINGS

FIG. 1 is a system configuration diagram illustrating a schematic configuration of a display system 1.

FIG. 2 is a conceptual diagram illustrating a relationship among a first display device 10, a second display device 20, and a shooting range.

FIG. 3 is a functional block diagram illustrating schematic functions of an information processing device 40.

FIG. 4 is a flowchart illustrating an operation of an imaging device 30.

FIG. 5 is a flowchart illustrating an operation of the information processing device 40.

FIG. 6 is a flowchart illustrating an operation of a video signal output device.

FIG. 7 is a flowchart illustrating an operation of a display device.

FIG. 8 is a diagram showing a configuration of an information processing device 40A.

### DESCRIPTION OF EMBODIMENTS

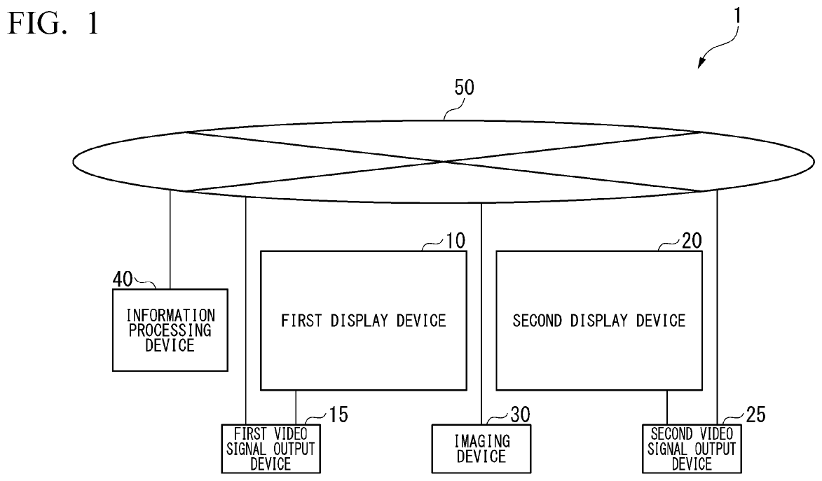

FIG. 1 is a system configuration diagram illustrating a schematic configuration of a display system 1.

The display system 1 includes a first display device 10, a first video signal output device 15, a second display device 20, a second video signal output device 25, an imaging device 30, an information processing device 40, and a network 50.

The first video signal output device 15, the second video signal output device 25, the imaging device 30, and the information processing device 40 are communicatively connected via the network 50. The first display device 10 is electrically connected to the first video signal output device 15 via a video cable. The second display device 20 is electrically connected to the second video signal output device 25 via a video cable.

The imaging device 30 has a function of continuously capturing a video at an arbitrary frame rate and a function of transmitting the captured image, which is a result of the capturing, to the information processing device 40 via the network 50. The imaging device 30 may be, for example, a network camera with an image sensor.

The information processing device 40 is, for example, a computer, and realizes various functions by having a CPU (Central Processing Unit) read and execute programs stored in a storage device.

Each of the first video signal output device 15 and the video signal output device 25 has functions of: a storage unit configured to receive and store default contents and targeted contents from the information processing device 40 connected via the network; a reception unit configured to receive from the information processing device 40, a playback instruction to play a default content or a targeted content; a content extraction unit configured to extract a content to be output, from among the default contents and the targeted contents stored in the storage unit, based on the playback instruction received from the information processing device 40; a video output unit configured to output a video to the display device connected via the video cable.

For example, the first video signal output device 15 and the second video signal output device 25 may be any of a signage player, a computer, a video playback device, and the like.

The first display device 10 displays in a display region, a video signal supplied from the first video signal output device 15. For example, the first display device 10 may be a liquid crystal display that displays a video signal in a display region of a display screen of a display panel.

The second display device 20 displays in a display region, a video signal supplied from the second video signal output device 25. For example, the second display device 20 may be a liquid crystal display that displays a video signal on a display screen (display region) of a display panel.

A case where the first display device 10 and the second display device 20 are liquid crystal displays will be described, but they may be projectors. In the case where they are projectors, the first display device 10 and the second display device 20 may perform displaying by projecting video signals onto the display regions of the screens.

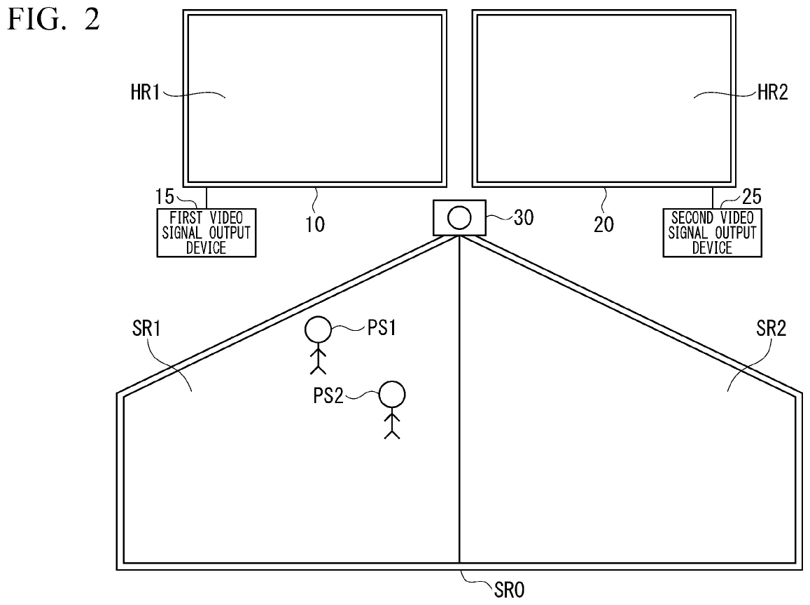

FIG. 2 is a conceptual diagram illustrating a relationship among the first display device 10, the second display device 20, and a shooting range.

The first display device 10 and the second display device 20 are installed adjacently so as to be close to each other. Here, as an example, the display regions are arranged in a horizontal direction and installed adjacent to each other so that the display regions face substantially the same direction. Alternatively, the first display device 10 and the second display device 20 may be installed so as to sandwich an entrance. Further, the first display device 10 and the second display device 20 may be installed so as to be aligned in the horizontal direction, or may have a certain degree of height difference in a height direction. Further, the sizes of the respective display screens of the first display device 10 and the second display device 20 may be the same, or need not necessarily be the same. Further, regarding positions where the first display device 10 and the second display device 20 are arranged, the first display device 10 may be arranged on a left side, and the second display device 20 may be arranged on a right side as viewed from a viewer. Alternatively, the first display device 10 may be arranged on the right side, and the second display device 20 may be arranged on the left side. Further, a display region HR1 of the first display device 10 may be a first display region, and a display region HR2 of the second display device 20 may be a second display region. Alternatively, the display region HR1 of the first display device 10 may be a second display region, and the display region HR2 of the second display device 20 may be a first display region.

Here, a region where the display screen of the first display device 10 can display a video signal is referred to as a first display region. A region where the display screen of the second display device 20 can display a video signal is referred to as a second display region.

Further, although a case where the first display region and the second display region correspond respectively to two single display devices will be described, the first display region and the second display region may be realized by dividing a display region of a display screen of a single display device into two. Alternatively, a projection region projected from a single projector may be divided into a plurality of regions to display a first display region and a second display region.

Further, in the present embodiment, although a case where two display devices, the first display device 10 and the second display device 20, are used will be described, the number of display devices may be three or more. In this case, the number of shooting ranges (viewing regions) may be set to the same number as the number of display devices.

Further, the first display device 10 and the second display device 20 are installed in places where a plurality of people can visit, such as station premises, squares in front of stations, public facilities, and event venues. The first display device 10 and the second display device 20 are used as public displays when installed in a public place.

A shooting range SR0 is a region where both the display screens of the first display device 10 and the second display device 20 can be viewed. By looking in the direction of the display screen of the first display device 10 or the second display device 20 at any position in the shooting range SR0, a person (for example, a viewer) can visually recognize the display screen of the first display device 10 or the second display device 20 in the line of sight. Further, the shooting range SR0 may be any range as long as a video signal displayed on the first display device 10 or the second display device 20 is visually recognizable, and the sounds can also be heard when sounds are output from the first display device 10 or the second display device 20.

The shooting range SR0 includes a shooting range SR1 and a shooting range SR2.

The shooting range SR1 is mainly a region of the shooting range SR0, which corresponds to a direction in which the display screen of the first display device 10 faces. The shooting range SR2 is mainly a region of the shooting range SR0, which corresponds to a direction in which the display screen of the second display device 20 faces. Although depending on a shape of a region where the first display region HR1 and the first display region HR2 can be visually recognized, for example, a boundary between the shooting range SR1 and the shooting range SR2 may be set with reference to a line extending in a direction perpendicular to the display region of the first display device 10 or the second display device 20.

The imaging device 30 is provided between the first display device 10 and the second display device 20, and images the shooting range SR0. Here, although a case where the shooting range SR0 is captured by a single imaging device 30 will be described, a plurality of imaging devices may be used to capture respective parts of the shooting range SR0, so that a captured image of the entire shooting range SR0 can be obtained from the respective results of the capturing.

The shooting range SR0 is a region where users can pass through and may also stop. When a user passes through the shooting range SR0, the user may move from the shooting range SR1 to the shooting range SR2, and from the shooting range SR2 to the shooting range SR1. Further, there may be a user who passes through only the shooting range SR1, and there may be a user who passes through only the shooting range SR2.

This figure shows a case where users PS1 and PS2 are present in the shooting range SR1 at a certain moment, and no user is present in the shooting range SR2.

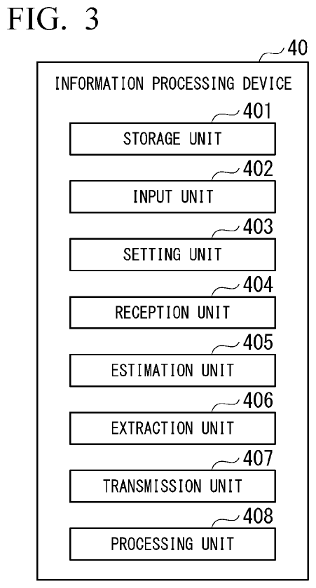

FIG. 3 is a functional block diagram illustrating schematic functions of the information processing device 40.

A storage unit 401 stores various data.

For example, the storage unit 401 stores various contents. Contents may be any contents as long as they include images visually recognizable by users, and may be still images or moving images. Further, contents may include not only images, but also sounds. Users can view (visually recognize) images when contents include only images, and can view images with sounds when contents include images and sounds.

Contents may be any of advertisements, notices, guidance, and the like. A content has a predetermined playback time. A playback time is a time from a start of a playback to an end of the playback. Examples of contents include a content with a playback time of 15 seconds and a content with a playback time of 30 seconds. Further, when a content is a still image, a playback thereof may be terminated in the middle after the playback is started, even before a playback end time comes, if there is a targeted content to be displayed preferentially.

Further, a playback time of a default content may be set shorter than a playback time of a targeted content. Since default contents end faster than targeted contents, end timings of default contents come faster, so that the opportunities for displaying targeted contents can be increased.

In the present embodiment, a case where contents are advertisements will be described as an example.

Contents include targeted contents and default contents.

A targeted content is a content corresponding to an attribute of a person included in an image captured by the imaging device 30. A targeted content is associated with attribute data indicating an attribute of a target and stored in the storage unit 401.

A default content is a content that is not related to a specific person. As a case where there is no relationship with a specific person, the default content may be any content as long as, for example, it is not a content corresponding to an attribute of, to be viewed by, a person included in an image captured by the imaging device 30. The default content may be any content as long as, for example, at least one content to be output according to the date and a time zone is selected.

An input unit 402 receives an operation input from an input device such as a mouse or a keyboard.

A setting unit 403 performs a process of setting data necessary in the display system 1.

For example, the setting unit 403 sets a shooting range of the imaging device 30 connected via the network 50 and associates the shooting range with a video signal output device. For example, the setting unit 403 identifies a region corresponding to the shooting range SR1 and a region corresponding to the shooting range SR2 from the captured image obtained from the imaging device 30, associates the shooting range SR1 with the first display device 10, and associates the shooting range SR2 with the second display device 20. Identification information may be assigned to a respective one of the first display device 10 and the second display device 20, so that the setting unit 403 performs the setting process by storing in the storage unit 401, an association relationship between the shooting range SR1 and the identification information of the first display device 10, and an association relationship between the shooting range SR2 and the identification information of the second display device 20.

Further, the setting unit 403 receives via the input unit 402, an operation input by an operator from the input device, and sets a targeted content and a default content according to the operation input.

A reception unit 404 receives a captured image transmitted from the imaging device 30. When image data is sequentially generated at the frame rate from the images captured by the imaging device 30, the reception unit 404 continuously receives the generated captured images. The reception unit 404 receives a captured image capturing the first shooting range SR1 and a captured image capturing the second shooting range SR2. The reception unit 404 may receive a captured image including the first shooting range SR1 and the second shooting range SR2.

An estimation unit 405 performs image recognition processing to detect a person from the captured image received by the reception unit 404 from the imaging device 30, and estimates an attribute, such as age or gender, of the person, based on a result of the detection.

As the function of detecting a person, the estimation unit 405 has a first detection function and a second detection function.

The first detection function of the estimation unit 405 detects a person from an image capturing the first shooting range including a position where each of the first display region and the second display region can be visually recognized, wherein the first shooting range and the second shooting range are included in a region where the first display region and the second display region different from the first display region can be visually recognized.

The second detection function of the estimation unit 405 detects a person from an image capturing the second shooting range which includes a position where each of the first display region and the second display region can be visually recognized and which is different from the first shooting range.

Attributes may include not only age and gender, but also occupation, clothing, and the like. The estimation unit 405 can also detect from which of the shooting ranges SR1 and SR2 in the received captured image the detected person has been detected.

The estimation unit 405 can estimate an attribute of the detected person after detecting from which of the shooting ranges SR1 and SR2 the person has been detected.

For example, the estimation unit 405 may input the captured image obtained from the imaging device 30 to a trained model that has undergone pre-learning, such as deep learning or the like, using a large number of images including people of various ages and genders, thereby performing the process of detecting a person and the process of estimating an attribute.

An extraction unit 406 extracts a targeted content based on the attribute estimated by the estimation unit 405.

A transmission unit 407 transmits various data.

For example, the transmission unit 407 reads the default contents or targeted contents stored in the storage unit 401 and distributes the read default contents or targeted contents to each of the first video signal output device 15 and the second video signal output device 25 which are connected via the network 50.

A processing unit 408 causes the transmission unit 407 to transmit to each of the first video signal output device 15 and the second video signal output device 25, a playback instruction to play a default content or a targeted content.

Further, the processing unit 408 may cause the transmission unit 407 to transmit different playback instructions respectively to a plurality of video signal output devices (for example, the first video signal output device 15 and the second video signal output device 25), according to the shooting ranges of the imaging device 30 and the positions and the number of detected viewers.

As a specific example, when a person is detected from a respective one of the first shooting range and the second shooting range, the processing unit 408 assigns to the first display region, a targeted content corresponding to the person detected from the image capturing the first shooting range, and assigns to the second display region, a targeted content corresponding to the person detected from the image capturing the second shooting range.

Further, when a plurality of persons are detected from the first shooting range, and no person is detected from the second shooting range, the processing unit 408 assigns to the first display region, a targeted content corresponding to a first person detected from the first shooting range, and assigns to the second display region, a targeted content corresponding to a second person detected from the first shooting range.

When a content is assigned to a display region, the content is displayed in the assigned display region.

Next, an operation of the display system 1 in the above-described configuration will be described.

### [Preparation]

Each of the first display device 10, the first video signal output device 15, the second display device 20, the second video signal output device 25, the imaging device 30, and the information processing device 40 is powered on. The first video signal output device 15, the second video signal output device 25, the imaging device 30, and the information processing device 40 are communicatively connected via the same network 50.

The first video signal output device 15 is connected to the first display device 10 via a video cable, and the second video signal output device 25 is connected to the second display device 20 via a video cable.

The imaging device 30 continuously transmits to the information processing device 40 via the network 50, captured images obtained by imaging the shooting range SR0 at an arbitrary frame rate.

The setting unit 403 of the information processing device 40 identifies the shooting range SR0 from the captured image captured by the imaging device 30 based on an operation input by an operator which is input from the input unit 402 via the input device, and divides the shooting range SR0 into the shooting range SR1 and the shooting range SR2. Further, based on an operation input by the operator, the setting unit 403 associates the shooting range SR1 with the first display device 10 and stores the association relationship in the storage unit 401, and also associates the shooting range SR2 with the second display device 20 and store the association relationship in the storage unit 401.

Based on an operation input by the operator via the input device, the information processing device 40 specifies a plurality of default contents to be default advertisements from a contents file stored in the storage unit 401, and distributes each default content to the first video signal output device 15 and the second video signal output device 25. Further, based on an operation input by the operator, the information processing device 40 sets, for each of a plurality of targeted contents, an attribute of viewers and identification information for identifying the targeted content, and distributes each targeted content to the first video signal output device 15 and the second video signal output device 25.

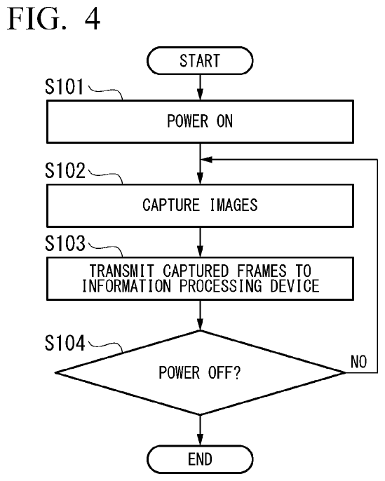

FIG. 4 is a flowchart illustrating an operation of the imaging device 30. When powered on (step S101), the imaging device 30 captures an image of a region including the shooting range SR0 at a predetermined frame rate (step S102), and transmits the captured image to the information processing device 40 (step S103).

The imaging device 30 determines whether or not an instruction to turn off the power has been input (step S104). When determining that an instruction to turn off the power has not been input (step S104-NO), the imaging device 30 proceeds to step S102. When determining that an instruction to turn off the power has been input (step S104-YES), the imaging device 30 terminates the processing.

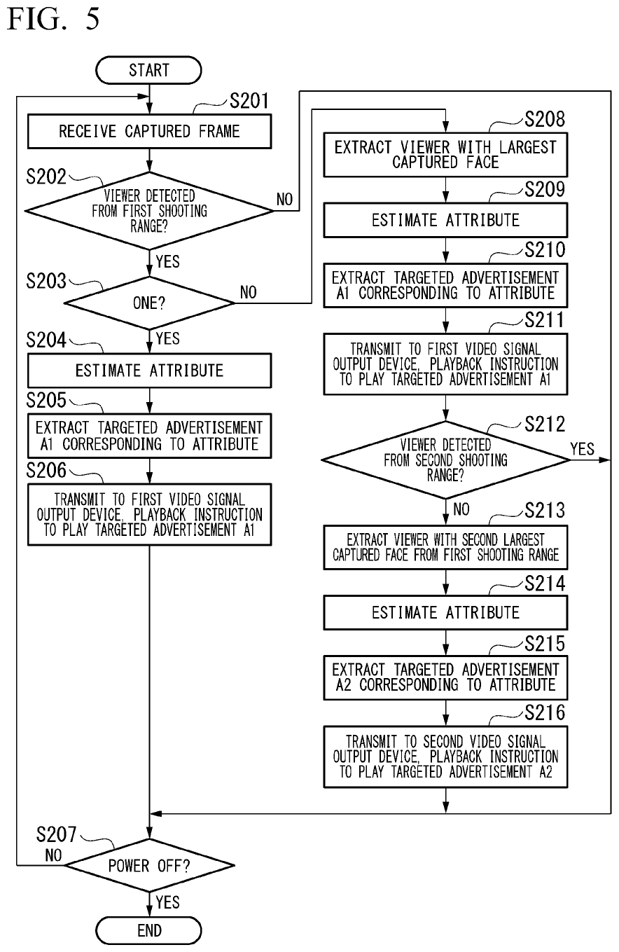

FIG. 5 is a flowchart illustrating an operation of the information processing device 40.

The processing shown in this flowchart is performed in parallel for each of the first video signal output device 15 and the second video signal output device 25. Here, as an example, a case where the processing is performed in the first video signal output device 15 will be described.

When the information processing device 40 receives a captured image from the imaging device 30 (step S201), the estimation unit 405 performs image recognition processing on the received captured image to determine whether or not a viewer has been detected from the first shooting range SR1 (step S202). When a viewer has been detected from the first shooting range SR1 (step S202-YES), the estimation unit 405 determines whether or not the number of viewers detected is one (step S203). When the number of viewers detected is one, the estimation unit 405 estimates an attribute of this viewer based on the image of the viewer detected (step S204). When obtaining a result of estimating an attribute, the estimation unit 405 outputs to the extraction unit 406, data indicating that one viewer has been detected from the first shooting range SR1 and the attribute of the viewer. The extraction unit 406 extracts a targeted content corresponding to the obtained attribute (step S205). For example, here, a targeted advertisement A1 is extracted as the targeted content corresponding to the obtained attribute.

When the targeted content has been extracted, the processing unit 408 transmits from the transmission unit 407 to the first video signal output device 15, a playback instruction to play the targeted advertisement A1 together with content identification information indicating that the extracted targeted content is the targeted advertisement A1 (step S206).

Here, when the targeted advertisement A1 is displayed on the first display device 10, it is possible to display in a visually recognizable manner, the targeted content (here, the targeted advertisement A1) corresponding to the attribute of the one viewer present in the first shooting range SR1. As a result, the viewer can view the targeted advertisement A1.

Thereafter, the information processing device 40 determines whether or not an instruction to turn off the power has been input (step S207). When an instruction to turn off the power has not been input (step S207-NO), the information processing device 40 proceeds to step S201.

In step S203, when the number of viewers detected from the first shooting range SR1 is not one (step S203-NO), that is, when a plurality of viewers have been detected, the estimation unit 405 detects, based on a first condition and an image of each viewer detected, a viewer who satisfies the first condition (step S208). As the first condition, any condition can be used, such as the size of the face of the detected person (viewer). It is considered that the larger the size of the face, the closer the distance from the shooting range where the person has been detected to the display device associated with the detected shooting range. By displaying the targeted content to a viewer who is closer to the display device, it is possible to increase the likelihood that the targeted content will be viewed by the viewer.

The size of the face may be obtained, for example, by identifying an image region corresponding to the face and obtaining the area of the image region, or by counting the number of pixels included in the image region corresponding to the face. When a viewer with the largest captured face has been detected, the estimation unit 405 estimates an attribute of this viewer based on the image of the detected viewer (step S209). When obtaining a result of estimating an attribute, the estimation unit 405 outputs to the extraction unit 406, data indicating that a viewer has been detected from the first shooting range SR1 and the attribute of the viewer. The extraction unit 406 extracts a targeted content corresponding to the obtained attribute (step S210). For example, here, a targeted advertisement A1 is extracted as the targeted content corresponding to the obtained attribute.

When the targeted content has been extracted, the processing unit 408 transmits from the transmission unit 407 to the first video signal output device 15, a playback instruction to play the targeted advertisement A1 together with content identification information indicating that the extracted targeted content is the targeted advertisement A1 (step S211).

The estimation unit 405 determines whether or not a viewer has been detected from the second shooting range SR2, based on the result of the image recognition processing performed on the captured image in which the viewer has been detected from the first shooting range SR1 in step S202 (step S212).

When a viewer has been detected from the second shooting range SR2 (step S212-YES), the information processing device 40 determines whether or not an instruction to turn off the power has been input (step S207). When an instruction to turn off the power has not been input (step S207-NO), the information processing device 40 proceeds to step S201.

Here, when a viewer has been detected from the second shooting range SR2, the targeted content based on the person detected from the first shooting range SR1 is displayed on the first display device 10, but is not displayed on the second display device 20. On the second display device 20, a targeted content corresponding to the person detected from the second shooting range SR2 is displayed preferentially over the targeted content corresponding to the person detected from the first shooting range SR1.

Here, the targeted content corresponding to the attribute of the viewer present in the first shooting range SR1 is displayed on the first display device 10, and the targeted content corresponding to the attribute of the viewer present in the second shooting range SR2 is displayed on the second display device 20. As a result, the viewer present in the first shooting range SR1 can view the targeted content displayed on the first display device and the viewer present in the second shooting range SR2 can view the targeted content displayed on the second display device 20.

In step S212, when a viewer has not been detected from the second shooting range SR2 (step S212-NO), the estimation unit 405 detects, based on a second condition and an image of each viewer detected from the first viewing region SR1, a viewer who satisfies the second condition (step S213). As the second condition, any condition can be used. For example, similarly to the first condition, the size of the face of the viewer detected may be used as the second condition. Alternatively, a condition different from the first condition may be used. When the second condition is different from the first condition, the second condition may be a condition of selecting a viewer who is different from the viewer selected based on the first condition, and who faces toward the second display region (for example, the second display region HR2). Here, a content displayed on the second display region can be viewed even by a viewer who is present in the first shooting range, as long as the viewer faces the second display region.

Alternatively, the second condition may be a condition of selecting a person, who is different from the first person, based on a distance from the boundary between the first shooting range SR1 and the second shooting range SR2. Here, by selecting a viewer who is closer to the boundary between the first shooting range SR1 and the second shooting range SR2, based on the distance from the boundary therebetween, even if the viewer is present in the first shooting range SR1, it is possible to increase the possibility that a content displayed on the second display region will be viewed.

Here, when the size of the face is used as the second condition, the estimation unit 405 detects a viewer with the second largest captured face from the first shooting range SR1 (step S213). When a viewer with the second largest captured face has been detected (S212-YES), the estimation unit 405 estimates an attribute of this viewer based on the image of the detected viewer (step S214). When obtaining a result of estimating an attribute, the estimation unit 405 outputs to the extraction unit 406, data indicating that the second viewer has been detected from the first shooting range SR1 and the attribute of the second viewer. The extraction unit 406 extracts a targeted content corresponding to the obtained attribute (step S215). For example, here, a targeted advertisement A2 is extracted as the targeted content corresponding to the obtained attribute.

When the targeted content has been extracted, the processing unit 408 transmits from the transmission unit 407 to the second video signal output device 25, a playback instruction to play the targeted advertisement A2 together with content identification information indicating that the extracted targeted content is the targeted advertisement A2 (step S216).

As a result, when a plurality of persons have been detected from the first shooting range SR1, and no person has been detected from the second shooting range SR2, the processing unit 408 can display in the first display region, the targeted content corresponding to the first person selected from the first shooting range SR1 based on the first condition, and display in the second display region, the targeted content corresponding to the second person who is different from the first person among the persons detected from the first shooting range SR1 and who is selected based on the second condition different from the first condition.

Here, the targeted content corresponding to the attribute of the viewer who is present in the first shooting range SR1 and has the largest captured face is displayed on the first display device 10, and the targeted content corresponding to the attribute of the viewer who is present in the first shooting range SR1 and has the second largest captured face is displayed on the second display device 20.

As a result, even when a plurality of viewers are present in the first shooting range SR1, no viewer is present in the second shooting range SR2, and no targeted content corresponding to a viewer present in the second shooting range SR2 is displayed on the second display device 20, it is possible to display on the second display device 20 as well, a targeted content corresponding to an attribute of a viewer present in the first shooting range SR1. As a result, even when a plurality of viewers are present in the first shooting range SR1, it is possible to give the chances of viewing targeted contents corresponding to attributes of the viewers present in the first shooting range SR1.

Although the case where the above-described processing of FIG. 5 is performed for the first video signal output device 15 has been described, the information processing device 40 also performs the processing in parallel for the second video signal output device 25. For this reason, when the processing is performed for the second video signal output device 25, for example, in step S202 described above, the estimation unit 405 of the information processing device 40 determines whether or not a viewer has been detected from the second shooting range SR2. Then, when a viewer has been detected from the second shooting range SR2 (step S202-YES) and the number of viewers is one (step S203-YES), the estimation unit 405 estimates an attribute of the viewer detected from the second shooting range SR2 (step S204). Then, the extraction unit 406 extracts a targeted content corresponding to the attribute (step S205). The processing unit 408 outputs to the second video signal output device 25, an instruction to play the extracted targeted content (step S206). As a result, the targeted content corresponding to the viewer present in the second shooting range SR2 is displayed on the second display device 20.

Further, when it is determined in step S203 that a plurality of viewers have been detected (S203-NO), the estimation unit 405 detects, based on the first condition, a viewer with the largest captured face among the plurality of viewers detected from the second shooting range SR2 (step S208), and estimates an attribute of the viewer detected (step S209). The extraction unit 406 extracts a targeted content corresponding to the estimated attribute (step S210). The processing unit 408 outputs to the second video signal output device 25, a playback instruction to play the extracted targeted content (step S211).

The estimation unit 405 determines whether or not a viewer has been detected from the first shooting range SR1 (step S212). When a viewer has been detected from the first shooting range SR1, the information processing device 40 proceeds to step S207. When a viewer has not been detected from the first shooting range SR1, the estimation unit 405 detects, based on the second condition and the image of each viewer detected from the second shooting range SR2, a viewer who satisfies the second condition (step S213). The second condition may be any of the size of the face, the orientation of the face, and a distance from the boundary between the first shooting range SR1 and the second shooting range SR2.

When a viewer who satisfies the second condition has been detected, the estimation unit 405 estimates an attribute of the viewer who satisfies the second condition (step S214). The extraction unit 406 extracts a targeted content corresponding to the estimated attribute (step S215). The processing unit 408 outputs to the second video signal output device 25, a playback instruction to play the extracted targeted content (step S216).

The information processing device 40 may perform the above-described processing each time a captured image is obtained from the imaging device 30. In this case, the processing unit 408 performs the processes of transmitting playback instructions in steps S206, S211, and S216 each time a captured image is obtained. In this case, the playback instructions may be continuously transmitted to the first video signal output device 15 and the second video signal output device 25, but as described later, the first video signal output device 15 and the second video signal output device 25 can play a targeted content according to the playback instruction received at the timing when the playback of the currently played targeted content or default content ends.

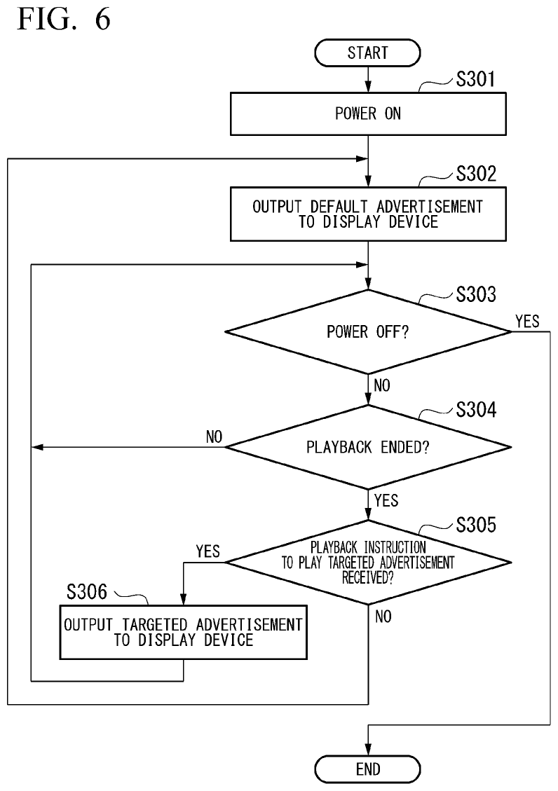

FIG. 6 is a flowchart illustrating operations of the first video signal output device and the second video signal output device 25. Although the operations of the first video signal output device 15 and the second video signal output device 25 are the same, a targeted content to be played according to a playback instruction output from the information processing device 40 differs. Further, also when a content given as a default content differs, the default content to be played differs. Here, the operation of the first video signal output device 15 will be explained, and a description of the operation of the second video signal output device 25 will be omitted.

When powered on (step S301), the first video signal output device 15 receives default contents and targeted contents from the information processing device 40, stores them in the storage unit of the first video signal output device 15, and start playing a default content. When the playback of the default content is started, the first video signal output device 15 outputs to the first display device 10, a video signal for displaying the default content whose playback has been started (step S302). The first video signal output device 15 determines whether or not an instruction to turn off the power is input (step S303). When determining that an instruction to turn off the power is input (step S303-YES), the first video signal output device 15 terminates the processing. When determining that an instruction to turn off the power has not been input (step S303-NO), the first video signal output device 15 determines whether or not the playback of the content has ended (step S304). Here, a content has a predetermined playback time. The first video signal output device 15 determines whether or not an elapsed time from the start of the playback has reached a playback end time indicated by the playback time. In this step S304, regardless of whether the content being played is a default content or a targeted content, it is possible to similarly make the determination based on whether or not the playback end time of the content being played has come.

For example, when the first video signal output device 15 is in the middle of playing a default content, and the playback end time of the playback time set to the default content has not come, the first video signal output device 15 determines that the playback has not ended (step S304-NO), and proceeds to step S303. When determining that the playback end time of the playback time set to the default content has come (step S304-YES), the first video signal output device 15 determines whether or not a playback instruction to play a targeted content has been received from the information processing device 40 (step S305). Here, it may be determined whether or not the playback end time has come. Alternatively, it may be determined whether or not it is immediately before the playback end time. Whether or not it is immediately before the playback end time may be determined based on whether or not the time, which is a predetermined time (for example, one second) before the playback end time, has come.

When determining that a playback instruction to play a targeted content has not been received (step S305-NO), the first video signal output device 15 proceeds to step S302.

As a result, when the playback of one default content ends, the first video signal output device 15 displays the same default content or another default content on the first display device 10. For example, when no viewer is present in both the first shooting range SR1 and the second shooting range SR2, or when no viewer is present in the first shooting range SR1 and one viewer is present in the second shooting range SR2, a default content can be displayed on the first display device 10.

When determining that a playback instruction to play a targeted content has been received (step S305-YES), the first video signal output device 15 outputs to the first display device 10, a video signal for displaying the targeted content corresponding to the received playback instruction (step S306). Then, the first video signal output device 15 proceeds to step S303.

Here, when one viewer is present in the first shooting range SR1, even when one or more viewers are present in the second shooting range SR2, the first video signal output device 15 displays on the first display device 10, a targeted content corresponding to an attribute of the viewer detected from the first shooting range SR1. Further, when a plurality of viewers are present in the first shooting range SR1, the first video signal output device 15 displays on the first display device 10, a targeted content corresponding to an attribute of a viewer with the largest captured face among the viewers present in the first shooting range SR1.

Although the operation of the first video signal output device 15 has been described as an example in FIG. 6, the same processing is performed in the second video signal output device 25 as well. However, the display devices corresponding respectively to the first video signal output device 15 and the second video signal output device 25 are different, and different content playback instructions are input from the information processing device 40 to the first video signal output device 15 and the second video signal output device 25. Therefore, even if the processing is the same, a display device targeted for displaying and a content to be displayed differ according to a playback instruction.

For example, the second video signal output device 25 can display a default content on the second display device 20 when no viewer is present in both the first shooting range SR1 and the second shooting range SR2, or when no viewer is present in the second shooting range SR2 and one viewer is present in the first shooting range SR1.

When displaying a default content, if a default content different from that for the first video signal output device 15 is set in step S302, the second video signal output device 25 displays on the second display device 20 in step S302, the default content different from that displayed on the first display device 10.

Further, when determining in step S305 that a playback instruction to play a targeted content has been received from the information processing device 40, the second video signal output device 25 displays on the second display device 20, the targeted content corresponding to the playback instruction received from the information processing device 40.

Here, when one viewer is present in the second shooting range SR2, even when one or more viewers are present in the first shooting range SR1, the second video signal output device 25 displays on the second display device 20, a targeted content corresponding to an attribute of the viewer detected from the shooting range SR2. Further, when a plurality of viewers are present in the second shooting range SR2, the second video signal output device 25 displays on the second display device 20, a targeted content corresponding to an attribute of the viewer with the largest captured face among the viewers present in the second shooting range SR2.

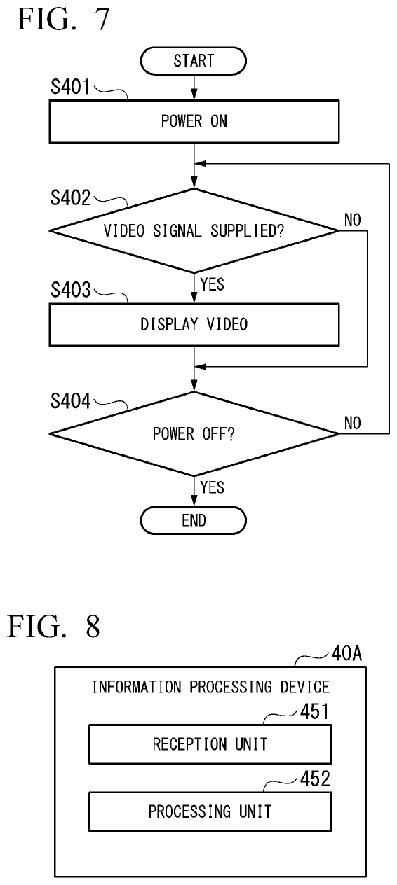

FIG. 7 is a flowchart illustrating operations of the first display device 10 and the second display device 20. Although the operations of the first display device 10 and the second display device 20 are the same, a content to be displayed differs according to a content output from the video signal output device connected via the video cable. Here, the operation of the first display device 10 will be described, and a description of the operation of the second display device 20 will be omitted.

When powered on (step S401), the first display device 10 determines whether or not there is a video signal supplied from the first video signal output device 15 (step S402). When there is a video signal (step S402-YES), the first display device 10 displays in the first display region HR1, the video signal supplied from the first video signal output device 15 (step S403). The first display device 10 determines whether or not an instruction to turn off the power has been input (step S404). When determining that an instruction to turn off the power has not been input (step S404-NO), the first display device 10 proceeds to step S402. When determining that an instruction to turn off the power has been input (step S404-YES), the first display device 10 terminates the processing.

Where there is no video signal in step S402, the first display device 10 proceeds to step S404.

As a result, the first display device 10 can display the video signal supplied from the first video signal output device 15.

Further, the second display device 20 performs the same processes as in steps S401 to S404 described above, and when there is a video signal supplied from the second video signal output device 25, displays the supplied video signal.

FIG. 8 is a diagram showing a configuration of an information processing device 40A which is another embodiment of the information processing device 40. The information processing device 40A includes a reception unit 451 and a processing unit 452.

The reception unit 451 receives an image capturing a first shooting range and a second shooting range different from the first shooting range, the first shooting range and the second shooting range being included in a region in which a first display region and a second display region different from the first display region are visible.

When a person is detected from a respective one of the first shooting range and the second shooting range based on the image, the processing unit 452 assigns to the first display region, a content corresponding to the person detected from the first shooting range, and assigns to the second display region, a content corresponding to the person detected from the second shooting range. When a plurality of persons are detected from the first shooting range and no person is detected from the second shooting range, the processing unit 452 assigns to the first display region, a content corresponding to a first person detected from the first shooting range, and assigns to the second display region, a content corresponding to a second person detected from the first shooting range.

The content assigned to the first display region is displayed in the first display region. The content assigned to the second display region is displayed in the second display region.

In the embodiment described above, the processing unit 408 of the information processing device 40 may determine a targeted content according to a playback status of the contents displayed respectively on the first display device 10 and the second display device 20.

For example, when a first default content and a second default content are displayed respectively in the first display region and the second display region, and a playback of the second default content displayed in the second display region ends before a playback of the first default content displayed in the first display region, the processing unit 408 may perform a process (process A) of displaying in the second display region, after the playback of the second default content displayed in the second display region ends, a first targeted content corresponding to a person selected based on a first condition from among the plurality of persons present in the first shooting range.

For example, when no viewer is detected from the second shooting range and a person is detected from the first shooting range at the timing when a playback end time of the second default content displayed on the second display device 20 comes, a first targeted content can be displayed on the second display device 20 without waiting until the playback of the first default content being played on the first device 10 ends. As a result, it is possible to increase the opportunities for providing targeted contents to viewers present in the first shooting range.

Further, in the above-described embodiment, when the above-described process A has been performed, the playback of the first default content displayed in the first display region has ended, and the first targeted content displayed in the second display region has not ended, the processing unit 408 of the information processing device 40 may display in the first display region, a second targeted content which is different from the first targeted content being played in the second display region and which corresponds to any of the persons present in the first shooting range.

As a result, for example, a targeted content can be displayed on the first display device 10 in response to the end of the playback of a default content displayed on the first display device 10. At this time, since the playback of a targeted content displayed in the second display region has not ended, a targeted content different from the targeted content being played in the second display region can be displayed on the first display device 10. This can prevent the same targeted content from being displayed on both the first display device 10 and the second display device 20. This allows viewers to have the chance to view multiple types of targeted contents.

Further, according to the above-described embodiment, it is possible to provide a digital signage system that can dynamically control, using a plurality of display devices, contents to be played, including targeted contents.

Further, according to the above-described embodiment, when a plurality of viewers are recognized from a captured image captured by the imaging device 30, the information processing device 40 can automatically select an effective playback pattern and display according to the playback pattern, a plurality of targeted contents using at least one of the first display device 10 and the second display device 20. As a result, the effect of the targeted contents to be viewed can be enhanced.

Further, according to the above-described embodiment, by dividing a shooting range of the imaging device 30 into a plurality of regions and associating each shooting range with a video signal output device, there is an advantage that the number of imaging devices can be reduced, compared to a conventional system having a plurality of targeted contents. That is, there is an advantage that it is sufficient to use a smaller number of imaging devices than the number of divided shooting ranges.

Further, a program for realizing the functions of the respective units of the information processing device 40 in FIG. 1 or a program for realizing the functions of the respective units of the information processing device 40A in FIG. 8 may be recorded in a computer-readable recording medium, so that a computer system can read and execute the program recorded in the recording medium to perform execution managements. Here, the “computer system” referred to here includes an OS and hardware such as peripheral devices.

Further, the “computer system” includes home page providing environments (or display environments) when the WWW system is used.

Further, the “computer-readable recording medium” refers to portable media such as flexible disks, magneto-optical disks, ROMs and CD-ROMs, and storage devices such as hard disks built into computer systems. Further, the “computer-readable recording medium” includes a medium that retains a program for a certain period of time, such as a volatile memory inside a computer system that serves as a server or a client. Further, the above-described program may be one for realizing part of the above-described functions, or one capable of realizing the above-described functions in combination with a program already recorded in the computer system. Further, the above-described program may be stored in a predetermined server, so that it will be distributed (downloaded, or the like) via a communication line in response to a request from another device.

Although the embodiments of the present disclosure have been described in detail with reference to the drawings, the specific configurations are not limited to those embodiments, and include designs and the like within the scope of the gist of the present disclosure.

1. An information processing device comprising:
a reception unit configured to receive an image capturing a first shooting range and a second shooting range different from the first shooting range, the first shooting range and the second shooting range being included in a region in which a first display region and a second display region different from the first display region are visible; and
a processing unit configured to
when a person is detected from a respective one of the first shooting range and the second shooting range based on the image, assign to the first display region, a content corresponding to the person detected from the first shooting range, and assign to the second display region, a content corresponding to the person detected from the second shooting range, and
when a plurality of persons are detected from the first shooting range and no person is detected from the second shooting range, assign to the first display region, a content corresponding to a first person detected from the first shooting range, and assign to the second display region, a content corresponding to a second person detected from the first shooting range.

2. The information processing device of claim 1, wherein
the processing unit is configured to, when the plurality of persons are detected from the first shooting range and no person is detected from the second shooting range, assign to the first display region, the content corresponding to the first person selected based on a first condition from among the plurality of persons detected from the first shooting range, and assign to the second display region, the content corresponding to the second person who is different from the first person and who is selected based on the first condition or a second condition different from the first condition, from among the plurality of persons detected from the first shooting range.

3. The information processing device of claim 2, wherein
the first condition is a condition based on a size of a face of a person detected from the first shooting range,
the second condition is at least one of
a condition of selecting a person who is different from the first person and who faces the second display region, and
a condition of selecting a person different from the first person, based on a distance from a boundary between the first shooting range and the second shooting range, and
the processing unit is configured to select the first person and the second person based respectively on the first condition and the second condition.

4. The information processing device of claim 2, wherein
the processing unit is configured to, when a first default content and a second default content are assigned respectively to the first display region and the second display region, and a playback of the second default content displayed in the second display region ends before a playback of the first default content displayed in the first display region ends, display in the second display region, after the playback of the second default content displayed in the second display region ends, a first content corresponding to a person selected based on the first condition from among the plurality of persons present in the first shooting range.

5. The information processing device of claim 4, wherein
the processing unit is configured to, when the playback of the first default content displayed in the first display region has ended, and the first content displayed in the second display region has not ended, display in the first display region, a second content which is different from the first content being played in the second display region and which corresponds to any of the plurality of persons present in the first shooting range.

6. A content display method comprising:
receiving an image capturing a first shooting range and a second shooting range different from the first shooting range, the first shooting range and the second shooting range being included in a region in which a first display region and a second display region different from the first display region are visible;
when a person is detected from a respective one of the first shooting range and the second shooting range based on the image, assigning to the first display region, a content corresponding to the person detected from the first shooting range, and assigning to the second display region, a content corresponding to the person detected from the second shooting range; and
when a plurality of persons are detected from the first shooting range and no person is detected from the second shooting range, assigning to the first display region, a content corresponding to a first person detected from the first shooting range, and assigning to the second display region, a content corresponding to a second person detected from the first shooting range.

7. The content display method of claim 6, further comprising:
when the plurality of persons are detected from the first shooting range and no person is detected from the second shooting range, assigning to the first display region, the content corresponding to the first person selected based on a first condition from among the plurality of persons detected from the first shooting range, and assigning to the second display region, the content corresponding to the second person who is different from the first person and who is selected based on the first condition or a second condition different from the first condition, from among the plurality of persons detected from the first shooting range.

8. The content display method of claim 7, wherein
the first condition is a condition based on a size of a face of a person detected from the first shooting range, and
the second condition is at least one of
a condition of selecting a person who is different from the first person and who faces the second display region, and
a condition of selecting a person different from the first person, based on a distance from a boundary between the first shooting range and the second shooting range.

9. The content display method of claim 7, further comprising:
when a first default content and a second default content are assigned respectively to the first display region and the second display region, and a playback of the second default content displayed in the second display region ends before a playback of the first default content displayed in the first display region ends, displaying in the second display region, after the playback of the second default content displayed in the second display region ends, a first content corresponding to a person selected based on the first condition from among the plurality of persons present in the first shooting range.

10. The content display method of claim 9, further comprising:
when the playback of the first default content displayed in the first display region has ended, and the first content displayed in the second display region has not ended, displaying in the first display region, a second content which is different from the first content being played in the second display region and which corresponds to any of the plurality of persons present in the first shooting range.

11. A content display method using a first display device having a first display region and a second display device having a second display region, the content display method comprising:
when a person is present in a respective one of a first region and a second region different from the first region, the first region and the second region being included in a region in which the first display region and the second display region are visible, displaying on the first display device, a content corresponding to the person present in the first region, and displaying on the second display device, a content corresponding to the person present in the second region; and
when a plurality of persons are detected from the first region and no person is detected from the second region, displaying on the first display device, a content corresponding to a first person detected from the first region, and displaying on the second display device, a content corresponding to a second person detected from the first region.

12. The content display method of claim 11, further comprising:
when the plurality of persons are detected from the first region and no person is detected from the second region, displaying on the first display device, the content corresponding to the first person selected based on a first condition from among the plurality of persons detected from the first region, and displaying on the second display device, the content corresponding to the second person who is different from the first person and who is selected based on the first condition or a second condition different from the first condition, from among the plurality of persons detected from the first region.

13. The content display method of claim 12, wherein
the first condition is a condition based on a size of a face of a person detected from the first region, and
the second condition is at least one of
a condition of selecting a person who is different from the first person and who faces the second display region, and
a condition of selecting a person different from the first person, based on a distance from a boundary between the first region and the second region.

14. The content display method of claim 12, further comprising:
when a first default content and a second default content are displayed respectively in the first display region and the second display region, and a playback of the second default content displayed in the second display region ends before a playback of the first default content displayed in the first display region ends, displaying on the second display device, after the playback of the second default content displayed in the second display region ends, a first content corresponding to a person selected based on the first condition from among the plurality of persons present in the first region.

15. The content display method of claim 14, further comprising:
when the playback of the first default content displayed in the first display region has ended, and the first content displayed in the second display region has not ended, displaying on the first display device, a second content which is different from the first content being played on the second display device and which corresponds to any of the plurality of persons present in the first region.
